(19) United States
(12) Patent Application Publication
(10) Pub. No.: US 2024/0396090 A1
(43) Pub. Date: Nov. 28, 2024

(54) SOLID-STATE CELL BATTERY, AND METHOD FOR MANUFACTURING A SOLID-STATE BATTERY OF THIS KIND

(71) Applicant: Volkswagen Aktiengesellschaft, Wolfsburg (DE)

(72) Inventors: Tobias JANSEN, Braunschweig (DE); Christian KLEMT, Meine (DE); Alexander TORNOW, Ummern (DE)

(73) Assignee: Volkswagen Aktiengesellschaft, Wolfsburg (DE)

(21) Appl. No.: 18/797,234

(22) Filed: Aug. 7, 2024

Related U.S. Application Data
(63) Continuation of application No. PCT/EP2023/052764, filed on Feb. 6, 2023.

(30) Foreign Application Priority Data
Feb. 7, 2022 (DE) 10 2022 102 761.9

(51) Int. Cl. H01M 10/0583; H01M 10/04; H01M 10/0585; H01M 50/46

(52) U.S. Cl. CPC H01M 10/0583; H01M 10/0404; H01M 10/0454; H01M 10/0585; H01M 50/461

(57) ABSTRACT

A method for manufacturing a solid-state cell battery having a support film, a separator, a cathode and a continuous collector film. The support film is placed on a work table. A first layer of the continuous collector film is supplied by a roller device. The separator, cathode, and a further separator are arranged in a stacking process to form a cell stack. A second layer of the continuous collector film is supplied via a roller device. The collector film is positioned by a horizontal displacement of the work table and/or by a horizontal displacement of at least one guide roller of the roller device relative to the cell stack, as a result of which a fold is made in the collector film. A system for manufacturing a solid-state cell battery and a solid-state cell battery are also provided.

This nonprovisional application is a continuation of International Application No. PCT/EP2023/052764, which was filed on Feb. 6, 2023, and which claims priority to German Patent Application No. 10 2022 102 761.9, which was filed in Germany on Feb. 7, 2022, and which are both herein incorporated by reference.

### BACKGROUND OF THE INVENTION

### Field of the Invention

The invention relates to a solid-state cell battery as well as a method for manufacturing a solid-state cell battery of this type.

### Description of the Background Art

To produce solid-state cell batteries, solid, ionically conductive separators are used, which are manufactured for the most part from ceramic materials, which may not be continuously processed or formed. To manufacture a cell stack of a battery of this type, the separator may therefore not be folded around the anode and the cathode in a z-shaped manner as is the case with classic lithium-ion batteries having a liquid electrolyte. This limitation may be explained by the characteristic material properties of the separator material, on the one hand, and by the thickness of the separator, on the other hand.

To manufacture cell stacks, single-sheet stackers are preferably used, in which the battery stack is built layer by layer. The battery stack is assembled from individual electrodes and separators and grows in height piece by piece. An essential disadvantage of a method of this type is the comparatively long process time for assembling a cell stack from individual elements, due to the many stacking operations. A further disadvantage in manufacturing a solid-state cell battery with the aid of a single-sheet stacker is due to the fact that a conventional single-sheet stacker is unable to place a collector applied with adhesive. An adhesive would therefore have to be applied for certain cell types by an additional robot during and after the collector placement. This is particularly challenging due to the electrical conductivity of the adhesive and the aerosol-type application of the adhesive.

By using a Z fold, the productivity may be increased by approximately 25% during the stacking of the cell stack solely due to the reduction in the number of layers, as is the case of a conventional lithium-ion battery. In addition, a Z folding process would permit the use of a collector which is already wetted with an adhesive, thus making it possible to avoid a large number of problems. The cell stack would also have a higher mechanical stability, which makes the otherwise comparatively unstable cell stack significantly easier to handle.

Z-folded solid-state electrodes for solid-state cells are currently unknown. A process for the corresponding folding of an electrode or a separator has also been unknown up to now, due to the described material properties of the ceramic separator material.

A method is known from DE 10 2015 201 281 A1 for manufacturing a solid-state cell battery, in particular a lithium-ion solid-state cell, which includes a first conductor layer and a second conductor layer and at least one separation layer, which are stacked to form a layer stack made up of at least two first conductor layers and at least two second conductor layers. The first conductor layer is separated from the second conductor layer by the separation layer. The layers of the first conductor layer separated by the separation layer and/or the layers of the second conductor layer separated by the separation layer are electrically connected to each other in layers. At least one of the conductor layers is formed from a flexible web, the flexible web being placed into the layer stack as a continuous layer, which is jointly formed at least by the two first conductor layers and/or the two second conductor layers. A solid-state cell battery is also known from DE 10 2015 201 281 A1, which is manufactured according to a method of this type.

WO 2017/158 319 A1, which corresponds to US 2019/0115627, and which discloses a method for manufacturing an energy storage device, in which a stack is formed, which comprises at least one first electrode layer, a first current collecting layer, and an electrolyte layer arranged between the first electrode layer and the first current collecting layer. For this purpose, a first groove is formed in the stack through the first electrode layer and the electrolyte layer, whereby exposed edges of the first electrode layer and the electrolyte layer are formed. At least a portion of the first groove is then filled with an electrically insulating material, whereby the exposed edges of the first electrode layer and the electrolyte layer are covered by the insulating material. The insulating material and the first current collecting layer are cut along at least a portion of the first groove to form an exposed edge of the first current collecting layer.

A method for manufacturing a galvanic lithium-ion cell is known from DE 10 2016 219 661 A1. A separator is provided for the spatial separation of a first electrode material of the lithium-ion cell from a second electrode material. It is provided that the first electrode material is applied to a first side of the separator by means of coating. A galvanic lithium-ion cell is also known from DE 10 2016 219 661 A1, which corresponds to US 2021/0280845, which is manufactured according to a method of this type.

### SUMMARY OF THE INVENTION

It is therefore an of the invention to simplify the manufacturing of a solid-state cell battery and to overcome the known disadvantages of the prior art.

This object is achieved, in an example, by a method for manufacturing a solid-state cell battery, which includes a support film, a separator, a cathode, as well as a continuous collector film. The method includes the following steps: placing the support film on a worktable; supplying a first layer of the continuous collector film with the aid of a roller device; supplying the separator, the cathode, as well as a further separator in a stacking process, a cell stack being formed; and supplying a second layer of the continuous collector film, the continuous collector film being supplied with the aid of a roller device, the continuous collector film being positioned by a horizontal displacement of the worktable and/or by a horizontal displacement of at least one guide roller of the roller device relative to the cell stack, whereby a fold is achieved in the collector film.

It is particularly advantageous if the solid-state cell battery does not include a solid anode which is formed by a stacking of a lithium anode on the cell stack, but instead includes an anode which is formed in-situ on the surface of the separator facing away from the cathode. Alternatively, the separator may also be metallically coated on the side facing the collector film. An additional stacking option may thus be spared during the manufacturing of the cell stack, which significantly speeds up the manufacturing of the solid-state cell battery.

The proposed method permits a much faster and simpler manufacturing of solid-state cell batteries. In particular, the process time for manufacturing a solid-state cell battery may be shortened, since the collector film is not applied to the cell stack by means of an additional stacking process, but instead is supplied by a roller device as continuous material, in particular as strip or film material. In a method of this type, in particular, only the collector film and not the separator is folded, whereby the stacking operations may be reduced by 25% during the manufacturing of the cell stack. If, instead of the separator and cathode, a function unit made up of the separator and cathode, a so-called monocell, is supplied during the stacking of the cell stack, the number of stacking operations may be further reduced. if the function unit comprises a separator, a cathode, and a further separator, and if it is designed as a so-called bicell, the number of stacking operations may be even further reduced, and the cycle time for manufacturing the solid-state cell battery may be shortened even more.

The collector film can be provided with an adhesive layer at least on one side of the collector film, and the collector film is glued to the cell stack when the collector film is positioned relative to a free surface of the cell stack. The manufacturing process may be further improved and sped up by applying an adhesive layer to the collector film. Additional gluing processes may also be omitted, which increases the process safety in the manufacturing process. Moreover, the mechanical stability of the cell stack is increased, since the components of the cell stack are fixed on the collector film by the adhesive layer. In particular, the handling of the cell stack as well as the stacking of further elements of the cell stack, in particular further separators, cathodes, are made easier thereby.

The adhesive layer can be applied to the collector film as a UV-activatable adhesive and is activated with the aid of a UV radiation source, in particular a UV lamp, when the collector film is positioned relative to the cell stack. A UV-activatable adhesive permits a particularly easy supply of the collector film, since there is no danger of the collector film sticking to the guide rollers of the roller device while it is being supplied.

The adhesive layer can be applied to the collector film as a pressure-sensitive adhesive. A pressure-sensitive adhesive layer also makes it possible to easily and cost-effectively supply a collector film already provided with an adhesive layer to the cell stack of the solid-state cell battery and to glue this cell stack to the collector film.

The adhesive layer can be applied to the collector film as a reactive adhesive, the reactive adhesive being activated upon contact with the cell stack or with the aid of an activator, in particular with air.

The collector film can be covered by a protective layer, in particular by a protective film, and this protective layer is removed when the collector film is supplied to the cell stack. In particular, the pressure-sensitive adhesive layer or the reactive adhesive may be covered by the protective layer until the collector film is supplied directly to the cell stack by a final guide roller of the roller device. The danger of a sticking to the roller device or the danger of too early an activation of the reactive adhesive may thus be minimized.

An adhesive can be applied to the cell stack, in particular sprayed thereon, and the collector film is glued to the cell stack.

The solid-state cell battery can have multiple compartments, the supply direction of the collector film being alternately changed between the different compartments. A meander-shaped fold of the collector film may be easily achieved thereby.

A height of the cell stack can be monitored, and the collector film is separated when the cell stack has reached a defined target height or a defined number of compartments. A separation of the collector film and a final gluing of the collector film to the cell stack may be initiated thereby.

The support film can be wound around the cell stack upon reaching a defined number of compartments or a defined stack height of the cell stack. An easy insulation of the cell stack is made possible thereby.

A further aspect of the invention relates to a system for manufacturing a solid-state cell battery of this type, the system comprising at least one worktable, at least one robot for building a cell stack, a roller device for supplying the collector film to the cell stack, a separating device for separating the collector film, and a control device. The control device includes a memory unit and a computing unit, a machine-readable program code being stored in the memory unit. The control device carries out a method described in the preceding paragraphs when the machine-readable program code stored in the memory unit is executed by the computing unit of the control device. A system of this type makes it possible to quickly and cost-effectively manufacture solid-state cell batteries.

A further aspect of the invention relates to a solid-state cell battery, which includes a support film, a first separator, a cathode, a second separator, as well as a continuous collector film, the solid-state cell battery being manufactured according to a method described in the preceding paragraphs. The manufacturing costs of a solid-state cell battery of this type may be lowered by reducing the stacking operations and shortening the amount of time required for the stacking process.

The collector film can be a metallic film, in particular a copper film, an aluminum film, or a plastic film having a coating made from an electrically conductive material. The use of a metallic film as the collector film is favorable so that the collector film is electrically conductive, on the one hand, and has a sufficiently high mechanical stability, on the other hand. With regard to the electrical conductivity and the ability to be supplied as continuous material, a copper film is particularly preferred as the collector film. Alternatively, a collector film made from aluminum or a collector film coated with aluminum may be used. This may work only in the case of solid-state cells, since no liquid electrolyte is present, which could dissolve the aluminum on the anode side.

The collector film may also have an additional coating with at least one additional layer. This layer may comprise, for example, an electrically conductive metal or a separator.

The collector film may also be made from a thermoplastic or thermosetting plastic, which is coated on both sides with an electrically conductive material, in particular copper, aluminum, or carbon.

A conductor contour can be formed on the collector film. The weight of the collector film may be reduced by the conductor contour. The electrical contacting of the compartment may also be simplified, since free spaces occur between the conductor contours in each case, which simplify the electrical contacting. In addition, the temperature distribution in the solid-state cell may be optimized by a targeted geometric design of the conductor contour, and the transfer resistance may be adapted to the contacting on the cathode side.

The collector film can be provided at least on one side with an adhesive layer made from an electrically conductive adhesive. The collector film can be provided with an electrically conductive adhesive on both sides. Alternatively or additionally, an electrically conductive adhesive can be applied to the collector film or a component to be bonded to the collector film. To permit an easy electron passage at the glue point, it is advantageous that at least one side of the collector film, preferably both sides of the collector film, is/are provided with an electrically conductive adhesive. This may take place, in particular, by a coating or a spray application of an adhesive.

The solid-state cell battery can comprise multiple compartments, the collector film being arranged in a meander-shaped or S-shaped manner between the individual compartments. A continuous material, in particular a film or strip material, may be easily bonded thereby to the fixed components, in particular the separators and cathodes of the cell stack.

The different examples of the invention mentioned in this application may be advantageously combined with each other unless otherwise indicated in the individual case.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of a solid-state cell battery according to the invention;

FIG. 2 shows a system for manufacturing a solid-state cell battery according to the invention;

FIG. 3 shows a method according to the invention for manufacturing a solid-state cell battery of this type; and

FIG. 4 shows a flowchart for carrying out a method according to the invention for the purpose of manufacturing a solid-state cell battery.

### DETAILED DESCRIPTION

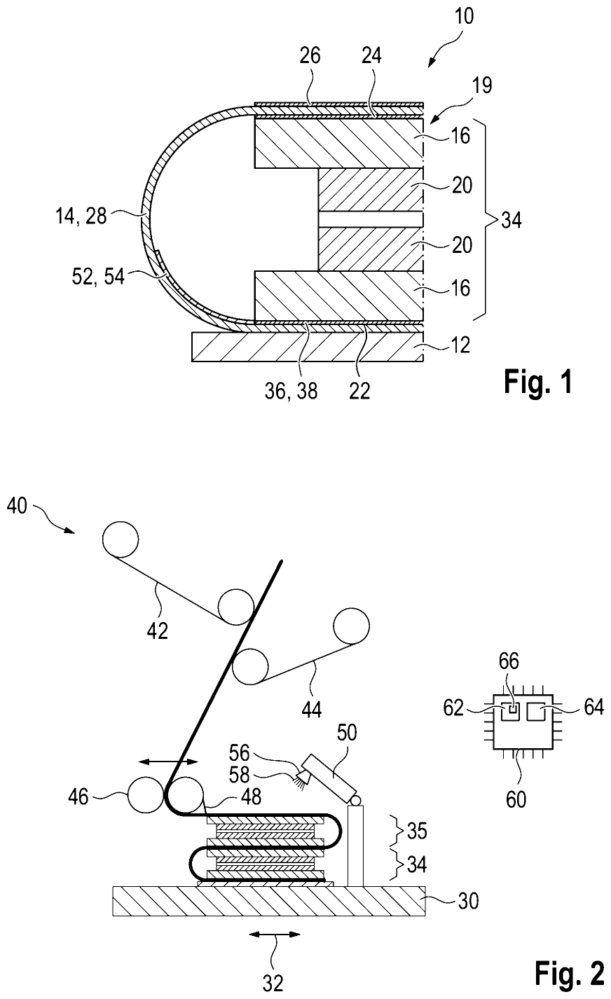

FIG. 1 shows a schematic representation of a cell stack 19 of a solid-state cell battery 10 according to the invention. Due to the structure of certain solid-state cell batteries 10, it is possible to fold a collector film 14 around a cell stack 19 made up of a separator 16 and a cathode 20 in a meander-shaped or S-shaped manner. A metallic collector film 14 wetted or coated with an electrically conductive adhesive is used, in particular an electrically conductive adhesive layer 24, in particular a copper film 28, an aluminum film, or a plastic film coated with an electrically conductive metal. An additional “pick-and-place” process may be avoided by the meander-shaped fold, whereby the process time for manufacturing solid-state cell battery 10 may be shortened. A conductor contour 22 may be formed on collector film 14. Adhesive layer 24 may include, in particular, a UV-activatable adhesive 26, a pressure-sensitive adhesive 36, or a reactive adhesive 38. A monocell having only one compartment 34 is illustrated in FIG. 1, although the proposed method is suitable, in particular, for solid-state cell batteries 10 having multiple compartments 34, 35, 37. Adhesive layer 24 may be designed as a single- or multi-component adhesive layer 24. If a protective layer 52, in particular a protective film 54, is applied to collector film 14, protective layer 52 is removed immediately before bonding collector film 14 to cell stack 19.

A system 100 for manufacturing a solid-state cell battery 10 of this type is illustrated in FIG. 2. System 100 comprises at least one worktable 30, at least one robot 50, in particular a pick-and-place system for building a cell stack 19, a roller device 40 for supplying collector film 14 to cell stack 19, a separating device 48 for separating collector film 14, and a control device 60 for controlling the manufacturing process. Control device 60 comprises a memory unit 62, in which a machine-readable program code 66 is stored, and a computing unit 64 for executing the program code. To manufacture solid-state cell battery 10, a support film 12, in particular a plastic substrate, is first placed and fixed on a worktable 30 illustrated in FIG. 2. Collector film 14 is then rolled onto and/or glued to this support film 12. The rolling of collector film 14 may take place, as illustrated in FIG. 2, by displacing one or multiple guide rollers 42, 44, 46 of a roller device 40 or by a displacement of worktable 30. As shown in FIG. 2, a roller device 40 is preferably with a first guide roller 42, a second guide roller 44, and a third guide roller 46. Collector film 14 is stretched by guide rollers 42, 44, 46. Third guide roller 46 is used to position collector film 14 relative to cell stack 19. First guide roller 42 and second guide roller 44 may also have additional functions in addition to the stretching function of collector film 14, in particular the application of an adhesive layer or the removal of a protective film 54 which is applied to collector film 14. A displacement device 32 is provided on worktable 30 for displacing worktable 30, with the aid of which worktable 30 may be displaced in the horizontal direction. In a following process step, a separator 16, a cathode 20, and a further separator 16 are placed by one or multiple robots 50 on collector film 14 in a defined manner to form a cell stack 19. After the placement of the battery elements, guide rollers 42, 44, 46 pass collector film 14 wetted with adhesive 24 over cell stack 19, collector film 14 being folded in a meander-shaped manner. The described procedure is repeated until a defined number of compartments 34, 35, 37 is reached. Collector film 14 is finally separated by a separating device 48 and is ready for building next cell stack 19. A robot 50 is preferably situated on each side of cell stack 19 to speed up the building of cell stack 19 and to increase the availability of the components. To speed up the building of cell stack 19, prefabricated structural elements may be used, which include a separator/cathode assembly or a separator/cathode/separator assembly. The anode (metallic lithium) of solid-state cell battery 10 may form in-situ on the side of separator 16 facing away from cathode 20. The anode may thus be part of separator 16 and may increase with each charging operation and decrease again with each discharging operation of solid-state cell battery 10. Alternatively, the anode may also be part of collector film 14 or form on a surface of the collector film facing separator 16. In principle, the metallic lithium of the anode is increased by electrochemical processes in the case of solid-state cell battery 10 according to the invention.

Robot 50 may have a spraying device 56, with the aid of which an adhesive 58 is applied to cell stack 19 to glue cell stack 19 to collector film 14.

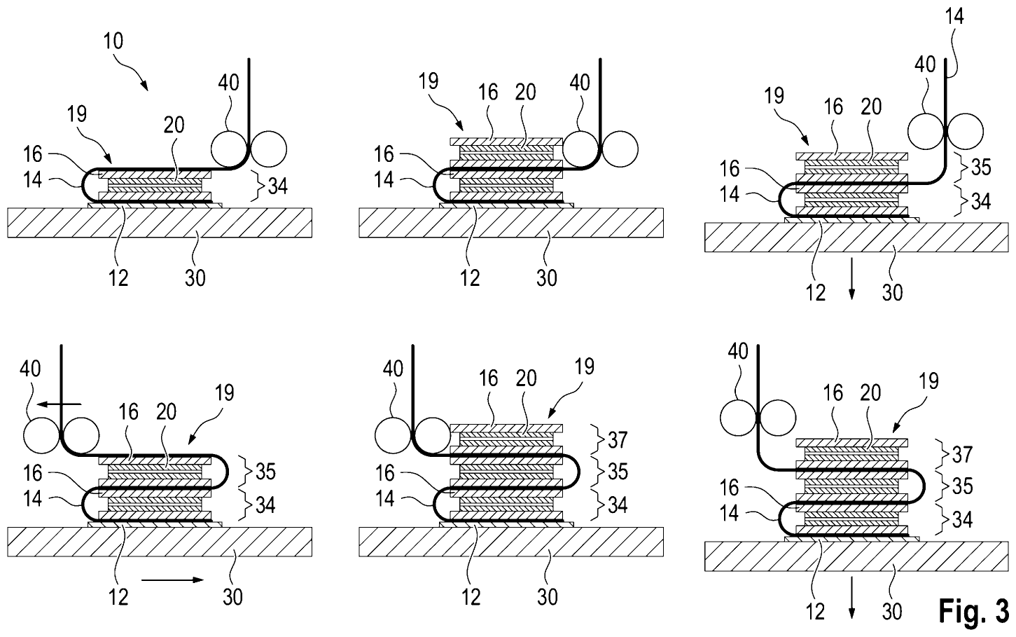

The sequence of steps in manufacturing a solid-state cell battery 10 according to the invention is illustrated in FIG. 3. As already discussed in relation to FIG. 2, a support film 12 is placed and fixed on work table 30 in a first manufacturing step. Collector film 14 is then rolled onto and/or glued to this support film 12, and corresponding separators 16 and cathodes 20 are stacked on collector film 14. A second layer of collector film 14 is then applied to cell stack 19, the supply direction being opposite the supply direction of the first layer of collector film 14. The supply is controlled by guide rollers 42, 44, 46 of roller device 40.

In a further process step 2, inflexible components 16, 18, 20 are again stacked on cell stack 19. In a process step 3. worktable 30 is furthermore displaced downwardly and/or bottom guide roller 46 of roller device 40 is displaced upwardly to create additional space for a further compartment 35, 37 of cell stack 19 of solid-state cell battery 10.

In a process step 4, bottom guide roller 46 of roller device 40 and/or the worktable is/are displaced in the horizontal direction to place a further layer of collector film 14 on cell stack 19 and to fold collector foil 19 in a meander-shaped manner, as described.

Further stacking operations of separator 16, anode 18, cathode 20, and other inflexible battery components take place in process step 5. In a final process step 6, collector film 14 is separated when a defined number of compartments 34, 35, 37 has been reached, or cell stack 19 has reached a defined height. The free end of collector film 14 is glued to the surface of separator 18 situated on top of cell stack 19.

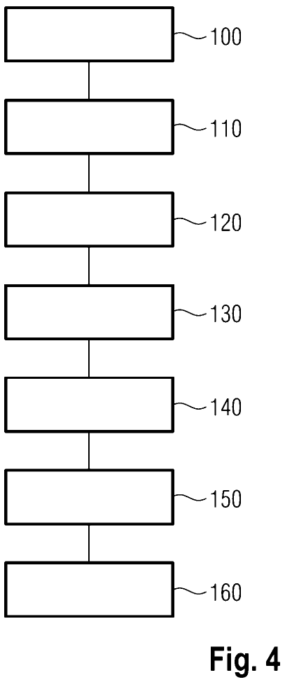

FIG. 4 shows a flowchart for manufacturing a solid-state cell battery 10 of this type. In a method step <100>, a support film 12, in particular a plastic substrate, is first placed on a worktable 30 and fixed thereto. In a method step <110>, collector film 14 is supplied in the form of a strip material and subsequently glued to support film 12 in a method step <120>. In a further method step <130>, a separator 16, a cathode, and a further separator 16 are stacked by one or multiple robots 50 on collector film 14, so that a cell stack 19 forms. In a method step <140>, worktable 30 and/or at least one guide roller 42, 44, 46 of roller device 40 are displaced to again supply collector film 14 to cell stack 19. This supply takes place in the direction opposite the first supply, so that collector film 14 is folded in a meander-shaped manner. The height of cell stack 19 or the number of compartments 34, 35, 37 of cell stack 19 are determined in a method step <150>. Once cell stack 19 has reached its target height and/or the desired number of compartments 34, 35, 37, collector film 14 is separated from the strip material in a method step <160> and finally glued to the surface of the last free separator 16.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing a solid-state cell battery comprising a support film, a separator, a cathode, and a continuous collector film, the method comprising:
placing the support film on a work table;
supplying a first layer of the continuous collector film with the aid of a roller device;
supplying the separator, the cathode, and a further separator in a stacking process to form a cell stack; and
supplying a second layer of the continuous collector film, the continuous collector film being supplied with the aid of a roller device, the continuous collector film being positioned by a horizontal displacement of the work table and/or by a horizontal displacement of at least one guide roller of the roller device relative to the cell stack such that a fold is achieved in the collector film.

2. The method for manufacturing a solid-state cell battery according to claim 1, wherein the collector film is provided with an adhesive layer at least on one side of the collector film, and wherein the collector film is glued to the cell stack when the collector film is positioned relative to a free surface of the cell stack.

3. The method for manufacturing a solid-state cell battery according to claim 2, wherein the adhesive layer is applied to the collector film as a UV-activatable adhesive and is activated with the aid of a UV radiation source when the collector film is positioned relative to the cell stack.

4. The method for manufacturing a solid-state cell battery according to claim 2, wherein the adhesive layer is applied to the collector film as a pressure-sensitive adhesive.

5. The method for manufacturing a solid-state cell battery according to claim 2, wherein the adhesive layer is applied to the collector film as a reactive adhesive, the reactive adhesive being activated upon contact with the cell stack.

6. The method for manufacturing a solid-state cell battery according to claim 3, wherein the collector film is covered by at least one protective layer or at least one protective film, which are removed when the collector film is supplied to the cell stack.

7. The method for manufacturing a solid-state cell battery according to claim 1, wherein an adhesive is sprayed onto the cell stack, and wherein the collector film is glued to the cell stack.

8. The method for manufacturing a solid-state cell battery according to claim 1, wherein the solid-state cell battery has multiple compartments, and wherein the supply direction of the collector film is alternately changed between the different compartments.

9. The method for manufacturing a solid-state cell battery according to claim 1, wherein a height of the cell stack is monitored, and wherein the collector film is separated when the cell stack has reached a defined target height.

10. The method for manufacturing a solid-state cell battery according to claim 1, wherein the support film is wound around the cell stack upon reaching a defined number of compartments or a defined stack height of the cell stack.

11. A system for manufacturing a solid-state cell battery, the system comprises:
at least one work table;
at least one robot for building a cell stack;
a roller device for supplying the collector film;
a separating device for separating the collector film; and
a control device, which includes a memory unit and a computing unit and machine-readable program code stored in the memory unit, the control device being configured to carry out the method according to claim 1 when the machine-readable program code is executed by the computing unit.

12. A solid-state cell battery comprising:
a support film;
a first separator;
a cathode;
a second separator; and
a continuous collector film,
wherein the solid-state cell battery is manufactured via the method according to claim 1.

13. The solid-state cell battery according to claim 12, wherein the collector film is a metallic film, a copper film, an aluminum film, or a plastic film coated with an electrically conductive metal.

14. The solid-state cell battery according to claim 12, wherein a conductor contour is formed on the collector film.

15. The solid-state cell battery according to claim 12, wherein the solid-state cell battery comprises multiple compartments, and wherein the collector film is arranged between the individual compartments in a meander-shaped or S-shaped manner.
